(19) United States
(12) Patent Application Publication
(10) Pub. No.: US 2025/0083499 A1
(43) Pub. Date: Mar. 13, 2025

(54) SERVICE HOLE COVER MEMBER FOR DOOR OF MOTOR VEHICLE

(71) Applicant: HOWA CO., LTD., Kasugai-shi (JP)

(72) Inventors: Kosuke UEDA, Kasugai-shi (JP); Kazuhiro OKADA, Kasugai-shi (JP); Keiya SABA, Kasugai-shi (JP)

(73) Assignee: HOWA CO., LTD., Kasugai-shi (JP)

(21) Appl. No.: 18/797,641

(22) Filed: Aug. 8, 2024

(30) Foreign Application Priority Data
Sep. 12, 2023 (JP) 2023-147295

(51) Int. Cl. B60J 5/04

(52) U.S. Cl. CPC B60J 5/0413; B60J 5/0418

(57) ABSTRACT

The service hole cover member is formed as the two-layer laminated body in which the cushion layer and the board member with sound-insulating performance and rigidity are laminated in this order. The cushion layer is formed of flexible elastic material with sound-absorbing performance and waterproof performance.

### BACKGROUND OF THE INVENTION

### Field of the Invention

The present invention relates to a service hole cover member for a door applied to a door of a motor vehicle.

### Description of the Related Art

Conventionally, as an example of this type of a service hole cover member for a door of a motor vehicle, a door structure for a motor vehicle described in Japanese Unexamined Patent Application Publication No. 2019-166950 has been proposed. In the door structure for a motor vehicle, a service hole cover is attached to a service hole formed in a door inner panel with its cover body so as to cover the service hole from the inner side thereof through a seal member.

Here, the service hole cover is formed of resin. The seal member is formed of a seal material such as butyl rubber or the like. The seal member serves to seal a gap at a boundary portion between the cover body and the door inner panel.

Incidentally, in the above-mentioned door structure for a motor vehicle, the material used to form the service hole cover is resin, while the material of the seal member is a seal material, as described above. Therefore, even if the service hole cover has sound-absorbing performance and sound-insulating performance and the seal member has waterproof performance, two components, the service hole cover and the seal member separate from the service hole cover, are necessary to protect the service hole from the viewpoints of sound absorption, sound insulation, and waterproofing. This not only unnecessarily increases the number of components, but also requires installation work of each of the service hole cover and the seal member. This results in the defect of lack of workability.

### SUMMARY OF THE INVENTION

It is, therefore, an object of the present invention to provide a service hole cover member for a door of a motor vehicle having all of sound insulation, sound absorption, and waterproofing performance with a single component.

For solving the above problem, a service hole cover member for a door of a motor vehicle according to the present invention is applied to a door of a motor vehicle.

In the service hole cover member for the door,
a cushion layer abutted along an inner panel, which is located facing an outer panel, from the side of the inner panel opposite to the outer panel so as to cover at least one service hole formed in the inner panel, the outer panel and the inner panel being included in a door body provided in the door.

A board member is laminated on the cushion layer so as to face the inner panel through the cushion layer.

The cushion layer is formed of a flexible elastic material having waterproof performance in addition to sound-absorbing performance.

The board member is formed so as to have a board shape with a non-metallic material having sound-insulating performance and rigidity.

According to such a configuration, the service hole cover member for a door of a motor vehicle according to the present invention is formed of the cushion layer abutting on the inner panel of the door body of the door from the opposite side of the outer panel, and the board member laminated on the cushion layer so as to face the inner panel through the cushion layer.

Here, the cushion layer is formed of a flexible elastic material having waterproof performance in addition to sound-absorbing performance. Meanwhile, the board member is formed of a non-metallic material having sound-insulating performance and rigidity.

According to such a configuration, while the cushion layer is formed of a flexible elastic material, the board member is formed of a non-metallic material having rigidity. This means that the cushion layer is more flexible than the board member.

Therefore, when a plurality of outer peripheral portions of the cushion layer are pressed by a plurality of pressing tools toward a plurality of corresponding outer peripheral portions of at least one service hole of the inner panel to the plurality of corresponding outer peripheral portions of the board member to the plurality of outer peripheral portions of the cushion layer, through a plurality of corresponding outer peripheral portions of the board member to the plurality of outer peripheral portions of the cushion layer, in a state where the cushion layer abuts on the inner panel from the side opposite to the outer panel, the board member compresses the plurality of outer peripheral portions of the cushion layer with its corresponding plurality of outer peripheral portions toward the corresponding plurality of outer peripheral portions of at least one service hole of the inner panel.

Accordingly, the cushion layer is pressed at the plurality of outer peripheral portions thereof under the pressure by the plurality of pressing tools so as to adhere to the corresponding plurality of outer peripheral portions of at least one service hole. This means that the cushion layer is pressed over the entirety of the outer peripheral portion thereof to adhere over the entirety of the outer peripheral portion of at least one service hole.

Thus, liquid such as water droplets or the like entering between the outer panel and the inner panel is well prevented from entering the opposite side of the inner panel to the outer panel by the cushion layer with waterproof performance thereof. As the result, not only the waterproof is achieved in this way, but also the liquid can be well prevented from entering the opposite side of the inner panel to the outer panel through the boundary between the outer peripheral portion of the cushion layer and the outer peripheral portion of at least one service hole of the inner panel by the cushion layer with the waterproof performance thereof.

As described above, the cushion layer has sound-absorbing performance, while the board member has sound-insulating performance. Therefore, sounds or noises, for instance, road noises and/or wind noises incident between the outer panel and the inner panel can be well absorbed by the cushion layer with the sound-absorbing performance thereof. Such sound absorption can be achieved while well preventing also road noises and/or wind noises from entering the opposite side of the outer panel from between the outer peripheral portion of the cushion layer and the outer peripheral portion of at least one service hole of the inner panel.

Moreover, the road noises and/or wind noises from the cushion layer attenuated by sound absorption as described above can be well insulated by the board member with the sound-insulating performance thereof.

According to the above, it becomes possible to provide a service hole cover member of a single component for a door of a motor vehicle having all of sound-absorbing performance, sound-insulating performance, and waterproof performance, with the two-layer laminated body formed of the cushion layer and the board member.

Additionally, in the service hole cover member for a door of a motor vehicle according to the present invention described above,
the flexible elastic material that is a forming material of the cushion layer is soft urethane foam, rubber foam, or elastomer foam having a volume density within a predetermined volume density range, and
the predetermined volume density range is set so that the soft urethane foam, the rubber foam, or the elastomer foam exerts waterproof performance.

According to such a configuration, too, the same work/effects as those of the service hole cover member for a door of a motor vehicle according to the present invention described above can be achieved.

Moreover, in the service hole cover member for a door of a motor vehicle according to the above-described present invention in which soft urethane foam, rubber foam, or elastomer foam described above is used as the forming material of the cushion layer, the predetermined volume density range is set to 0.005 g/cm³ to 0.1 g/cm³.

As a result, the work/effects of the service hole cover member for a door of a motor vehicle according to the present invention in which soft urethane foam, rubber foam, or elastomer foam described above is used as the forming material of the cushion layer can be more specifically achieved.

In the service hole cover member for a door of a motor vehicle according to the present invention described above, the non-metallic material that is a forming material of the board member is a synthetic resin material having sound-insulating performance and rigidity.

Accordingly, the work/effects of the service hole cover member for a door of a motor vehicle according to the above-described present invention can be more specifically achieved.

In an aspect of the present invention, in the service hole cover member for a door of a motor vehicle according to the present invention described above,
the board member is formed so as to have a board shape with a two-layer laminated body including both of a non-air permeable layer laminated on the cushion layer so as to face the inner panel through the cushion layer, and a hard layer laminated on the non-air permeable layer so as to face the cushion layer through the non-air permeable layer.

The non-air permeable layer is formed of a polymeric material having sound-insulating performance. the hard layer includes a semi-rigid urethane foam layer and both glass fiber layers, the semi-rigid urethane foam layer is formed of semi-rigid urethane foam having sound-insulating performance and rigidity, and both the glass fiber layers are respectively formed of a plurality of glass fibers.

One glass fiber layer of both the glass fiber layers is laminated on the non-air permeable layer as one side glass fiber layer so as to face the cushion layer through the non-air permeable layer.

The semi-rigid urethane foam layer is laminated on the one side glass fiber layer so as to face the non-air permeable layer through the one side glass fiber layer.

The other glass fiber layer of both the glass fiber layers is laminated on the semi-rigid urethane form layer as the other side glass fiber layer so as to face the one side glass fiber layer through the semi-rigid urethane form layer.

According to such a configuration, the board member is formed so as to have a board shape. with a two-layer laminated body including a non-air permeable layer and a hard layer, differed from the service hole cover member for a door of a motor vehicle according to the present invention described above.

Here, the non-air permeable layer has sound-insulating performance. Moreover, the hard layer is formed of a three-layer laminated structure including the one side glass fiber layer, the semi-rigid urethane foam layer, and the other side glass fiber layer.

In the hard layer, the semi-rigid urethane foam layer has sound-insulating performance and rigidity. The one side and other side glass fiber layers on one side and the other side have rigidity due to a plurality of glass fibers thereof. This means that in the hard layer, the one side and other side glass fiber layers serve respectively with the rigidity thereof to reinforce the rigidity of the semi-rigid urethane foam layer. As a result, the rigidity of the hard layer can be increased even more.

As described above, while the cushion layer is formed of flexible elastic material, the hard layer of the board member is formed of a three-layer laminated structure in which the rigidity of the semi-rigid urethane foam layer is further increased by the rigidity of both the one side glass fiber layer and the other side glass fiber layer.

Therefore, in a state where the cushion layer abuts on the inner panel from the side opposite to the outer panel, when a plurality of outer peripheral portions of the cushion layer are pressed at a plurality of outer peripheral portions thereof toward a plurality of corresponding outer peripheral portions of at least one service hole of the inner panel to a plurality of corresponding outer peripheral portions of the non-air permeable layer to a plurality of outer peripheral portions of the hard layer, which correspond to the plurality of outer peripheral portions of the cushion layer, by a plurality of pressing tools through a plurality of corresponding outer peripheral portions of the hard layer to the plurality of outer peripheral portions of the cushion layer and a plurality of corresponding outer peripheral portions of the non-air permeable layer described above, the hard layer compresses the plurality of outer peripheral portions of the cushion layer toward the above-described corresponding plurality of outer peripheral portions of at least one service hole of the inner panel through a plurality of corresponding outer peripheral portions of the non-air permeable layer to the corresponding plurality of outer peripheral portions of the hard layer.

By the compression described above, the cushion layer is pressed so as to adhere to the above-described corresponding plurality of outer peripheral portions of at least one service hole under the pressing by the plurality of pressing tools described above. This means that the cushion layer is pressed over the entirety of the outer peripheral portion thereof to adhere to the entirety of the outer peripheral portion of at least one service hole.

As a result, liquid such as water droplets or the like entering between the outer panel and the inner panel can be well prevented from entering the opposite side of the inner panel to the outer panel by the cushion layer with waterproof performance thereof, as described above. Here, this prevention is achieved while also preventing entering of liquid to the opposite side of the outer panel from between the outer peripheral portion of the cushion layer and the outer peripheral portion of at least one service hole.

Additionally, the cushion layer has sound-absorbing performance. Meanwhile, in the board member, the non-air permeable layer has sound-insulating performance, and the one side and other side glass fiber layers of the hard layer play in enhancing the sound-insulating performance of the semi-rigid urethane foam layer even more with respective sound-insulating performance thereof. This means that the board member can exert even better sound-insulating performance by the synergistic operation of sound-insulating performances of the non-air permeable layer and the hard layer.

Therefore, sounds, for instance, road noises and/or wind noises incident between the outer panel and the inner panel are well absorbed by the cushion layer with the sound-absorbing performance thereof. In addition, the road noises and/or wind noises from the cushion layer attenuated by sound absorption in this way can be well insulated by the synergistic sound-insulating performance of the non-air permeable layer and hard layer described above.

According to the above, it is possible to provide a service hole cover member of a single component for a door of a motor vehicle which has all of sound-absorbing performance, sound-insulating performance, and waterproof performance, with the three-layer laminated structure including the cushion layer, and the non-air permeable layer and hard layer of the board member.

Moreover, in the service hole cover member for a door of a motor vehicle according to the present invention described above, the present invention comprises an outer peripheral laminated portion and at least one protruding laminated portion formed so as to correspond to the at least one service hole of the inner panel at an inner peripheral side of the outer peripheral laminate portion.

The at least one protruding laminated portion is formed to protrude from the outer peripheral laminated portion so as to be press-fitted into the at least one service hole from the opposite side of the inner panel to the outer panel.

According to the above, the at least one protruding laminated portion is protruded from the outer peripheral laminated portion to be press-fitted into the at least one service hole. Accordingly, entry of water droplets and/or sounds to the opposite side of the inner panel to the outer panel from the side of the outer panel through the inner panel can be well prevented even more effectively.

In another aspect, in the service hole cover member for a door of a motor vehicle according to the present invention, in which the board member is formed of the non-air permeable layer and the hard layer,

The present invention comprises an outer peripheral laminated portion, and at least one protruding laminated portion formed so as to correspond to the at least one service hole of the inner panel at an inner peripheral side of the outer peripheral laminated portion.

The at least one protruding laminated portion is formed to protrude from the outer peripheral laminated portion so as to be press-fitted into the at least one service hole from the opposite side of the inner panel to the outer panel.

According to such a configuration, the at least one protruding laminated portion is protruded from the outer peripheral laminated portion and is press-fitted into the at least one service hole. Accordingly, entry of water droplets or sounds to the opposite side of the inner panel to the outer panel from the side of the outer panel through the inner panel can be well prevented even more effectively, even when the board member is a laminated body of the non-air permeable layer and the hard layer.

In still another aspect, in the service hole cover member for a door of a motor vehicle according to the present invention, in which the board member is formed of the non-air permeable layer and the hard layer described above,

The present invention comprises a skin layer of non-woven fabric laminated on the other side glass fiber layer so as to face the semi-rigid urethane foam layer through the other side glass fiber layer.

Lamination of the other side glass fiber layer to the semi-rigid urethane foam layer is performed by impregnation of liquid isocyanate and its curing to the other side glass fiber layer.

According to such a configuration, the skin layer of non-woven fabric is laminated on the other side glass fiver layer. Therefore, as described above, for example, in lamination of the other side glass fiber layer to the semi-rigid urethane foam layer, even if liquid isocyanate seeps out from the other side glass fiber layer to the opposite side of the semi-rigid urethane foam layer, in the process in which the liquid isocyanate is impregnated to the other side glass fiber layer, the seeping isocyanate is well absorbed by the skin layer with the non-woven fabric thereof.

As a result, the appearance of the service hole cover member for the door viewed from the side of the skin layer can be well maintained, while the work/effects of the service hole cover member for a door of a motor vehicle according to the present invention in which the board member is formed of the non-air permeable layer and the hard layer can be achieved.

### BRIEF DESCRIPTION OF THE DRAWINGS

Other features and advantages of the present invention will be apparent from the following description taken in connection with the accompanying drawings.

FIG. 1 is a schematic partial cutaway view of a motor vehicle to which a first embodiment of a service hole cover member for a door of a motor vehicle according to the present invention is applied.

FIG. 2 is a schematic sectional view of a door body taken along a 2-2 line of FIG. 1.

FIG. 3 is a surface view of an inner panel to which a door service hole cover member of FIG. 2 is assembled.

FIG. 4 is a surface view of an inner panel of FIG. 2 as viewed from the side of an outer panel.

FIG. 5 is an enlarged perspective view of a pressing tool of FIG. 2.

FIG. 6 is a back view of a service hole cover member for a door of FIG. 2 as viewed from the side of a soft layer.

FIG. 7 is a sectional view of a service hole cover member for a door taken along a 7-7 line of FIG. 6.

FIG. 8 is a surface view of an inner panel to which a service hole cover member for a door of FIG. 2 is assembled as viewed from the side of an outer panel.

FIG. 9 is graphs indicating transfer function characteristics of a service hole cover member for a door of the first embodiment and a conventional service hole cover in relation to the frequency of sounds or noises.

FIG. 10 is a sectional view showing a second embodiment of a service hole cover member for a door of a motor vehicle according to the present invention.

FIG. 11 is a sectional view showing a third embodiment of a service hole cover member for a door of a motor vehicle according to the present invention.

### DETAILED DESCRIPTION OF THE PREFERRED EMBODIMENTS

Hereinafter, each of embodiments of the present invention will be described with reference to the drawings.

### First Embodiment

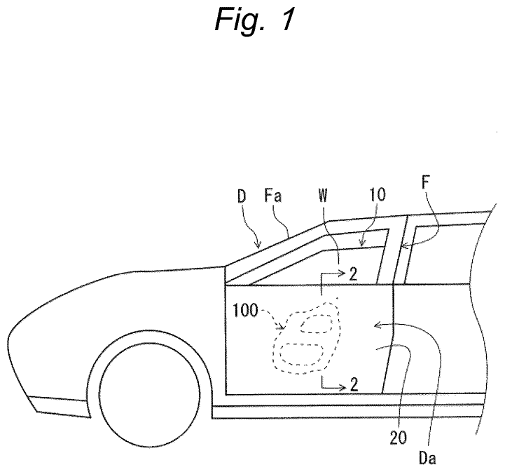

FIG. 1 shows a first embodiment of a service hole cover member for a door of a motor vehicle (hereinafter also referred to as service hole cover member) according to the present invention. The service hole cover member is applied to a front left door D of a motor vehicle. Note that in the first embodiment, hereinafter, the service hole cover member is referred to as the service hole cover member 100, and the front left door D is also simply referred to as the door D.

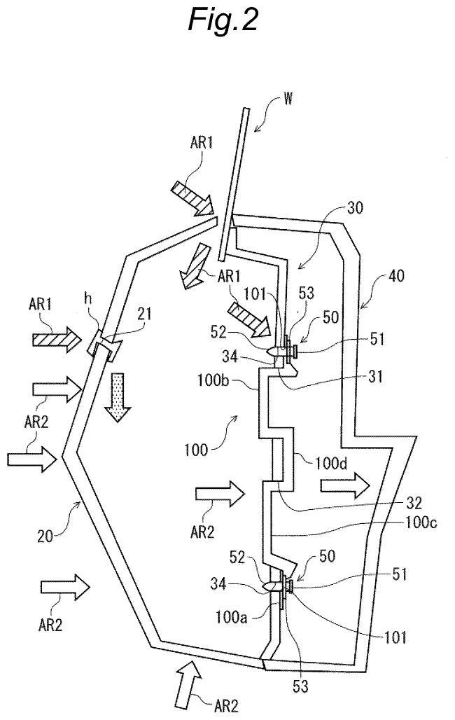

The door D is hinge-coupled to a front left pillar (not shown) of a front left door frame F of the motor vehicle to open and close a vehicle compartment 10 of the motor vehicle (see FIG. 1). As shown in FIG. 1 or 2, the door D includes an outer panel 20, an inner panel 30, and a door trim 40. The outer panel 20, the inner panel 30, and the door trim 40 are assembled to a lower frame portion of the front left door frame F to form a door body Da of the door D together with the front left door frame F. In addition, the forming material of each of the outer panel 20 and the inner panel 30 is, for example, an aluminum alloy sheet material.

The outer panel 20 is attached to the lower frame portion of the door frame F from the outside thereof (outside of the motor vehicle). The inner panel 30 is attached to the lower frame portion from the inside thereof (inside of the vehicle compartment) so as to face the outer panel 20. The door trim 40 is attached to the lower frame portion from the opposite side of the outer panel 20 so as to cover the inner panel 30 as a decorative interior component.

The door forms, as shown in FIG. 1, a window with a window glass W and an upper frame portion Fa of the front left door frame F. The window glass W is disposed in the upper frame portion Fa so as to be capable of moving up and down. Herein, the window glass W lowers according to a lowering operation of an elevator mechanism (not shown) and is accommodated between the outer panel 20 and the inner panel 30 through a gap between the opposite upper end portions of the outer panel 20 and the inner panel 30 to open the above-mentioned window. And the window glass W rises along the upper flame portion Fa according to a raising operation of the elevator mechanism to close above-mentioned window.

Next, the configuration of the service hole cover member 100 according to the present invention will be described in relation to the configuration of the inner panel 30.

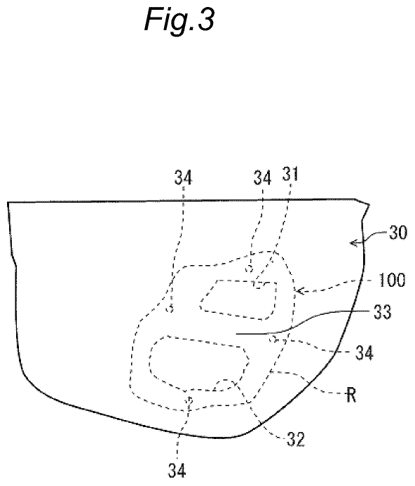

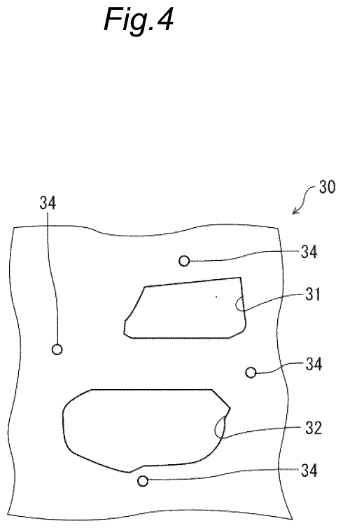

As shown in any of FIGS. 1 to 4, the inner panel 30 includes both upper and lower service holes 31 and 32. Both the upper and lower service holes 31 and 32 are spaced and formed vertically in an interval at a middle portion of the inner panel 30 1 as holes for working. In addition, a portion between both the upper and lower service holes 31 and 32 of the inner panel 30 is referred to as an inter-hole panel portion 33 (hereinafter also referred to as a hole common outer periphery portion 33). A region shown by a broken line R in FIG. 3 indicates an assembly region of the service hole cover member 100 to the inner panel 30.

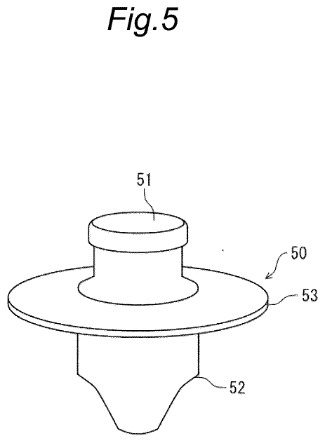

The service hole cover member 100 is assembled to the inner panel 30 with a plurality of pressing tools 50 (see FIG. 5) from the side of the door trim 40 as described later at the assembly region (region shown by the broken line R) of the service hole cover member 100 to the inner panel 30,

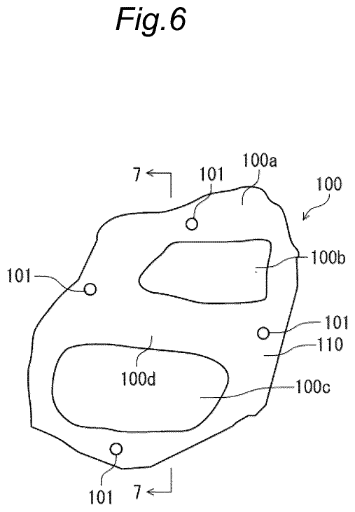

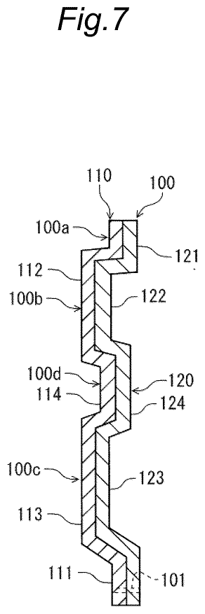

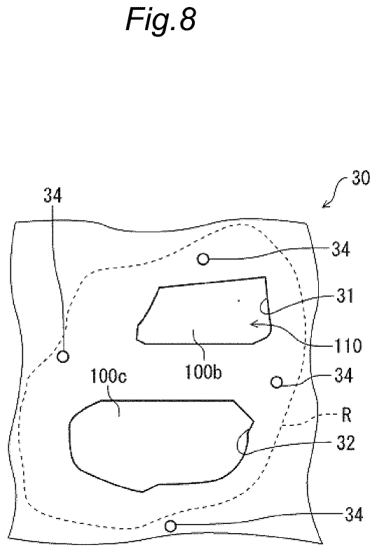

The service hole cover member 100 is formed in a shape shown in FIGS. 6 and 7. The service hole cover member 100 is formed of a soft layer 110 and a board member 120 so as to exhibit all of sound-absorbing performance, sound-insulating performance, and waterproof performance well, as shown in any of FIGS. 6 and 7. The service hole cover member 100 formed in such a manner is, as shown in FIG. 8, assembled at the soft layer 110 to abut on the inner panel 30. Note that in the first embodiment, the soft layer 110 is hereinafter referred to as a cushion layer 110.

The cushion layer 110 and the board member 120 which form the service hole cover member 100 are laminated in this order to form a two-layer laminated body. In the first embodiment, the two-layer laminated body is the service hole cover member 100, and therefore the two-layer laminated body is also indicated by the reference numeral 100 as in the case of the service hole cover member 100.

As shown in any of FIGS. 6 and 7, the service hole cover member 100, that is, the two-layer laminated body 100 is formed of an outer peripheral laminated portion 100a, both upper and lower protruding laminated portions 100b and 100c, and an inter-laminate portion 100d.

Here, the outer peripheral laminated portion 100a is formed in the two-layer laminated body 100 as an outer peripheral portion to both the upper and lower protruding laminated portions 100b and 100c and the inter-laminate portion 100d.

As shown in any of FIG. 2 and FIGS. 6 to 8, both the upper and lower protruding laminated portions 100b and 100c are protruded respectively toward the inner panel 30 from the outer peripheral laminated portion 100a and the inter-laminate portion 100d of the two-layer laminated body 100 in a shape that can be pressed into both the upper and lower service holes 31 and 32 of the inner panel 30 so as to correspond to both the upper and lower service holes 31 and 32 of the inner panel 30.

In the two-layer laminated body 100, the inter-laminate portion 100d is interposed between both the upper and lower protruding laminated portions 100b and 100c and serves to separate both the upper and lower protruding laminated portions 100b and 100c from each other.

In the two-layer laminated body 100, i.e., the service hole cover member 100 formed in this manner, both the upper and lower protruding laminated portions 100b and 100c are fitted by press-fitting into both the upper and lower service holes 31 and 32 of the inner panel 30 from the side of the door trim 40. Accordingly, the outer peripheral laminate portion 100a and the inter-laminate portion 100d are abutted on the assembly region (region indicated by broken line R) of the inner panel 30.

Moreover, the service hole cover member 100 is pressed at the outer peripheral laminated portion 100a onto the inner panel 30 by fastening or tightening the plurality of pressing tools 50 onto a plurality of female threaded holes 34 (see FIG. 2) of the inner panel 30 through a plurality of through holes 101 (see FIG. 6) as described later.

In the first embodiment, the plurality of through holes 101 are formed in the form of a penetrating shape in the vicinity of each of both the upper and lower protruding laminated portions 100b and 100c of the outer peripheral laminated portion 100a of the service hole cover member 100. In other words, the plurality of through holes 101 are formed in in portions of the outer peripheral laminate portion 100a of the service hole cover member 100 corresponding to the vicinity portions of both the upper and lower service holes 31 and 32 of the inner panel 30.

Meanwhile, the plurality of female threaded holes 34 are formed in portions of the assembly region (the region indicated by the broken line R) of the inner panel 30 corresponding to the through holes 101 of the outer peripheral laminated portion 100a. In other words, the plurality of female threaded holes 34 are formed respectively in the vicinity portions of both the upper and lower service holes 31 and 32 of the inner panel 30.

The reason for forming the plurality of through holes 101 and the plurality of female threaded holes 34 at such locations is as follows. That is, the reason is why the closer the pressing position of which the service hole cover member 100 (two-layer laminated body 100) is pressed by the plurality of pressing tools 50 on the inner panel 30 is to both the upper and lower service holes 31 and 32 (e.g., inner peripheral portion of each of both upper and lower service holes 31 and 32), the more the adhesion of the service hole cover member 100 to the inner panel 30 can be improved.

As shown in FIG. 5, the plurality of pressing tools 50 are respectively formed as a male screw member which includes a head portion 51 and a male screw portion 52 extending coaxially from the head portion 51. The plurality of pressing tools 50 further include respectively an annular brim or flange portion 53. The flange portion 53 is, for each pressing tools 50, formed coaxially with the head portion 51 and the male screw portion 52 between the head portion 51 and the male screw portion 52.

Under such a configuration, the plurality of pressing tools 50 are respectively fastened at its male screw portion 52 onto the female threaded hole 34 of the inner panel 30 through the through hole 101 of the service hole cover member 100, thereby to press an outer peripheral portion of the through hole 101 onto an outer peripheral portion of the female threaded hole 34 described above by the flange portion 53.

The configurations of the cushion layer 110 and the board member 120 will be described in detail. The cushion layer 110 is formed in a layer shape with soft urethane foam. Herein, the soft urethane foam is a material (a type of flexible elastic material) that exhibits good sound-absorbing performance and appropriately has flexible elasticity.

As shown in FIG. 7, the cushion layer 110 is formed to include an outer peripheral portion 111, both upper and lower protrusions 112 and 113, and an inter-protrusion portion 114.

Here, the outer peripheral portion 111 corresponds to a portion of the outer peripheral laminated portion 100a of the two-layer laminated body 100 corresponding to the outer peripheral portion 111. Both the upper and lower protrusions 112 and 113 correspond respectively to portions of both the upper and lower protruding laminated portions 100b and 100c of the two-layer laminated body 100 corresponding to both the upper and lower protrusions 112 and 113. The inter-protrusion portion 114 corresponds to a portion of the inter-laminated portion 100d of the two-layer laminated body 100 corresponding to the inter-protrusion portion 114.

Accordingly, in the cushion layer 110, both the upper and lower protrusions 112 and 113 are formed so as to protrude from the outer peripheral portion 111 and the inter-protrusion portion 114 (see FIG. 7).

The soft urethane foam which is the forming material of the cushion layer 110 is a type of flexible elastic material that can exert good sound-absorbing performance, as described above. Hence, in the first embodiment, for making the soft urethane foam exert also the good waterproof performance, the soft urethane foam is set at its volume density to have a value (e.g., 0.007 g/cm³) within a predetermined volume density range. In other words, the soft urethane foam can exert good waterproof performance by having a volume density within the predetermined volume density range. That is, such a soft urethane foam is a type of flexible elastic material that can exert good sound-absorbing performance and good waterproof performance.

Here, the predetermined volume density range is set to 0.005 g/cm³ to 0.1 g/cm³, for example. If the volume density of the soft urethane foam is outside the lower limit of the predetermined volume density range, the soft urethane foam lacks waterproof performance. If the volume density of the soft urethane foam exceeds the upper limit of the predetermined volume density range, the soft urethane foam lacks flexible elasticity.

The board member 120 is formed to have a board shape with polypropylene or foamed polypropylene that is a type of foamed synthetic resin material having appropriate rigidity and appropriate sound-insulating performance.

As shown in FIG. 7, the board member 120 is formed to include an outer peripheral portion 121, both upper and lower protrusions 122 and 123, and an inter-protrusion portion 124.

Here, the outer peripheral portion 121 correspond to a portion of the outer peripheral laminated portion 100a of the two-layer laminated body 100 corresponding to the outer peripheral portion 121. Both the upper and lower protrusions 122 and 123 correspond respectively to portions of both the upper and lower protruding laminate portions 100b and 100c of the two-layer laminated body 100 corresponding to both the upper and lower protrusions 122 and 123. The inter-protrusion portion 124 corresponds to a portion of the inter-laminated portion 100d of the two-layer laminated body 100 corresponding to the inter-protrusion portion 124.

Accordingly, in the board member 120, both the upper and lower protrusions 122 and 123 are formed so as to protrude from the outer peripheral portion 121 and the inter-protrusion portion 124 (see FIG. 7).

In the first embodiment configured in this way, the assembly of the service hole cover member 100 to the inner panel 30 is performed as in the followings.

For this assembly, the service hole cover member 100 is placed so as to face the inner panel 30 from the side of the door trim 40.

In such a state, the upper protruding laminated portion 100b and the lower protruding laminated portion 100c of the service hole cover member 100 are pressed into the upper service hole 31 and the lower service hole 32 of the inner panel 30. Therefore, sounds or noises, gases (e.g., air) and liquids (e.g., water) may not pass between the outer peripheral portion of the upper protruding laminated portion 100b and the inner peripheral portion of the upper service hole 31, and between the outer peripheral portion of the lower protruding laminated portion 100c and the inner peripheral portion of the lower service hole 32.

Additionally, in the state where both the upper and lower protruding laminated portions 100b and 100c are pressed into both the upper and lower service holes 31 and 32, as described above, the plurality of pressing tools 50 are sequentially fastened at their male screw portions 52 onto the corresponding female thread portions 34 of the inner panel 30 through the corresponding through holes 101 of the service hole cover member 100. As a result, the corresponding through holes 101 of the service hole cover member 100 are pressed at their outer peripheral portions onto the outer peripheral portions of the corresponding female threaded holes 34 of the inner panel 30 by the corresponding pressing tools 50 with the flange portions 53 thereof.

Here, the cushion layer 110 of the service hole cover member 100 has appropriate flexibility and appropriate elasticity. Additionally, polypropylene which is the forming material of the board member 120 of the service hole cover member 100 has appropriate rigidity.

Hence, in the service hole cover member 100 (two-layer laminated body 100), the board portion of the board member 120 corresponding to the outer peripheral laminated portion 100a is hard to deform unlike the cushion layer portion of the cushion layer 110 corresponding to the outer peripheral laminate portion 100a.

Therefore, when pressing is performed as described above, the portions of the above-described corresponding cushion layer portion of the cushion layer 110 corresponding to the outer peripheral portions of the female threaded holes 34 of the inner panel 30 are compressed by the above-described corresponding board portion of the board member 120 at portions of the corresponding board portion of the board member 120 corresponding to the flange portions 53 of the pressing tools 50.

With such compression, the above-described corresponding portion of the board member 120 is pressed at each portion thereof corresponding to each flange portion 53 of the pressing tools 50 onto each outer peripheral portion of the female threaded holes 34 of the inner panel 30 by each of the pressing tools 50 with the flange portions 53 thereof. This means that the cushion layer 110 is airtightly and liquid-tightly adhered to the outer peripheral portions of the female threaded holes 34 at portions of the above-described corresponding cushion layer portion corresponding to the outer peripheral portions of the female threaded holes 34 of the inner panel 30.

Hence, noises, gases, and liquids may not pass through both of the female threaded holes 34 of the inner panel 30 and the corresponding through holes 101 of the outer peripheral laminated portion 100a of the service hole cover member 100. Additionally, the larger the outer diameter of the flange portion 53 of each pressing tool 50 is, the wider the above-mentioned adhesion range is. Moreover, the above-described corresponding board portion is hard to deform, as described above. As a result of the above pressing, in the service hole cover member 100, each laminated portion of the outer peripheral laminate portion 100a located between the flange portions 53 of each of both adjacent pressing tools 50 of the plurality of pressing tools 50 can be adhered favorably to each portion of the inner panel 30 corresponding to each laminated portion of the outer peripheral laminate portion 100a.

Assume that the motor vehicle is traveling in the state which the service hole cover member 100 is assembled to the inner panel 30 of the door body Da of the door D, as described above. In such a state, if the motor vehicle is traveling in rainy weather, liquid (e.g., water droplets) may enter between the outer panel 20 and the inner panel 30 (see arrow AR1 of FIG. 2) through a hinge hole portion 21 (a supporting hole portion of hinge h of a door handle) of the outer panel 20 of the door body Da and/or a gap between upper end portions of the outer panel 20 and the inner panel 30.

Additionally, road noises generated from a traveling road surface of the motor vehicle through the front wheel of the motor vehicle and/or wind noises generated due to traveling of the motor vehicle may be incident toward the inner panel 30 through the outer panel 20 (see arrow AR2 of FIG. 2). Moreover, the road noises and/or) the wind noises may be incident between the outer panel 20 and the inner panel 30 from the hinge hole of the outer panel 20.

In response to the above, in the first embodiment, the cushion layer 110 is capable of exerting both sound-absorbing performance and waterproof performance favorably, as described above.

Additionally, in the service hole cover member 100, the upper protruding laminated portion 100b is firmly pressed into the upper service hole 31 in an airtight and liquid-tight manner, and the lower protruding laminated portion 100c is firmly pressed into the lower service hole 32 in an airtight and liquid-tight manner, as described above.

Under the flexibility of the cushion layer 110 and the rigidity of the board member 120, the cushion layer 110 is airtightly and liquid-tightly adhered to the outer peripheral portion of each of the female threaded holes 34 of the inner panel 30 at each portion thereof corresponding to each of the flange portions 53 of the plurality of pressing tools 50, as described above. Furthermore, under the flexibility of the cushion layer 110 and the rigidity of the board member 120, each cushion layer portion of the cushion layer 110 between each of the adjacent pressing tools 50 is also favorably adhered to a portion of the inner panel 30 corresponding to each cushion layer portion, as described above.

Therefore, even when water droplets enter between the outer panel 20 and the inner panel 30, the water droplets can be favorably prevented from entering the region between the inner panel 30 and the door trim 40 by the cushion layer 110 with the waterproof performance. As a result, the interior of the vehicle compartment 20 can be waterproofed favorably.

The cushion layer 110 exerts appropriate sound-absorbing performance. Therefore, even when road noises and/or wind noises are incident toward the inner panel 30 through the outer panel 20, the road noises and/or wind noises can be favorably absorbed by the cushion layer 110 with the sound-absorbing performance thereof.

Additionally, even if the road noises and/or wind noises absorbed and attenuated in this manner are incident on the board member 120 from the cushion layer 110, the road noises and/or wind noises can be favorably shielded by the board member 120 with the sound-insulating performance thereof.

As a result, the interior of the vehicle compartment 20 is favorably soundproofed by the service hole cover member 100 with the sound-absorbing performance of the cushion layer 110 and the sound-insulating performance of the board member 120.

According to the above, the service hole cover member 100 can be provided as a service hole cover member of a single component for a door of a motor vehicle that can also exert good waterproof performance, in addition to good sound-absorbing performance and good sound-insulating performance.

Incidentally, the acoustic performance of the service hole cover member 100 was measured in relation to the frequency of noises or sounds in the transfer function (FRP). For this measurement, the service hole cover described at the beginning of the present specification (hereinafter referred to as “the conventional service hole cover”) was prepared for comparison with the service hole cover member 100.

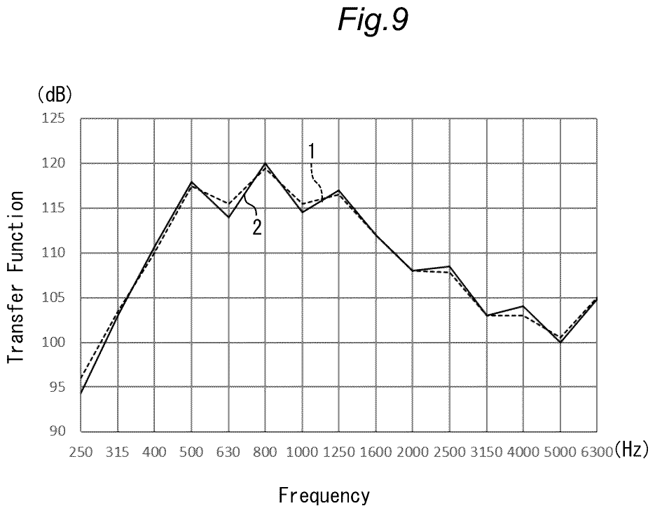

When measured the acoustic performance of the service hole cover member 100 and the conventional service hole cover was measured, graphs 1 and 2 shown in FIG. 9 were obtained. Graph 1 shows the acoustic performance of the service hole cover member 100 with relationship of transfer function (dB) to frequency (Hz). On the other hand, Graph 2 shows the acoustic performance of the conventional service hole cover with relationship of transfer function (dB) to frequency (Hz).

Comparing Graph 1 with Graph 2, it can be seen that the acoustic performance of the service hole cover member 100 is almost the same as that of the conventional service hole cover. In other words, the service hole cover member 100 is almost the same as the conventional service hole cover in terms of acoustic performance against road noises and/or wind noises, for instance, sound absorption-insulation performance.

However, the service hole cover member 100 is formed to include integrally both of the cushion layer 110 with waterproof performance, and the board member 120. Therefore, the service hole cover member 100 is formed as a two-layer laminated body of a single component which is formed integrally of the cushion layer 110 and the board member 120.

Furthermore, in the two-layer laminated body, the cushion layer 110 exerts sound-absorbing performance and waterproof performance, and the board member 120 exerts sound-insulating performance. In other words, the service hole cover member 100 is formed as a single component being capable of exerting all of sound-absorbing performance, sound-insulating performance, and waterproof performance.

In contrast, the conventional service hole cover, by itself, has only both of sound-absorbing performance and sound-insulating performance. Accordingly, the conventional service hole cover adopts separately a seal member with waterproof performance. In this case, the conventional service hole cover cannot exert all of the sound-absorbing performance, sound-insulating performance, and waterproof performance unless it is constructed by two components having also the seal member in addition to itself.

In other words, it can be said that the service hole cover member 100 is formed of a single component being capable of exerting all of the sound-absorbing performance, sound-insulating performance, and waterproof performance, differing from the conventional service hole cover.

### Second Embodiment

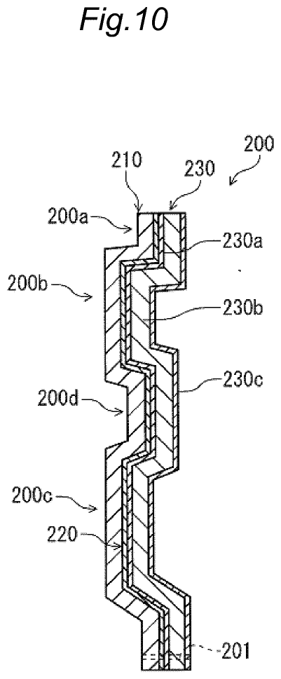

FIG. 10 shows a second embodiment of a service hole cover member for a door of a motor vehicle according to the present invention. In the second embodiment, a service hole cover member 200 is adopted instead of the service hole cover member 100 of the first embodiment.

The service hole cover member 200 is formed of a cushion layer 210 corresponding to the cushion layer 110 of the first embodiment and a two-layer laminated body including a film layer 220 and a hard layer 230 corresponding to the board member 120 of the first embodiment. In this second embodiment, the service hole cover member 200 is abutted on the inner panel 30 with the cushion layer 210 in the same manner as the cushion layer 110, instead of the cushion layer 110 of the first embodiment. In addition, a three-layer laminated body which is formed of the film layer 220 and the hard layer 230 of the two-layer laminated body, and the cushion layer 210 is also indicated by reference numeral 200 in the same manner as the service hole cover member 200.

The cushion layer 210 corresponds to the cushion layer 110 described in the first embodiment above. The cushion layer 210 is formed to have a shape similar to that of the cushion layer 110 with the same material as that of the cushion layer 110. The soft urethane foam which is the forming material of the cushion layer 210 is formed to have the same volume density as that of the soft urethane foam which is the material of the cushion layer 110. Note that the volume density is a value within the predetermined volume density range of the first embodiment.

The film layer 220 is formed as a non-air permeable layer that can exhibit good sound-insulating performance. The film layer 220 is laminated at its back face along the soft layer 210 from its surface face under adhesion by an adhesive material. Examples of the forming material of the film layer 220 include a type of polymeric material, for instance, a film made of nylon. The basis weight of the film is set to a value (e.g., 400 g/m²) within a predetermined basis weight range, and the thickness of the film is set to a value (e.g., 50 μm) within a predetermined thickness range.

The above-described predetermined basis weight range is set to 10 g/m² to 500 g/m². The reason why the lower limit of the predetermined basis weight range is set at 10 g/m² is because it is difficult to manufacture the film below the lower limit. The reason why the upper limit of the predetermined basis weight range is set at 500 g/m² is because the film, i.e., the film layer 220, becomes too heavy if the basis weight is higher than the upper limit.

The predetermined thickness range of the film is set to 10 μm to 500 μm. The reason why the lower limit of the predetermined thickness range is set at 10 μm is because the film is too thin below the lower limit and is difficult to manufacture. The upper limit of the predetermined thickness range is set at 500 μm because the film becomes too heavy when thicker than the upper limit.

The hard layer 230 is formed of a one side glass fiber layer 230a, a semi-rigid urethane foam layer 230b, and the other side glass fiber layer 230c so as to be capable of exhibiting good sound-insulating performance together with the film layer 220, and to have appropriate rigidity.

The one side glass fiber layer 230a is laminated on the film layer 220 under adhesion by an adhesive material so as to face the cushion layer 210 through the film layer 220.

The semi-rigid urethane foam layer 230b is laminated on the one side glass fiber layer 230a so as to face the film layer 220 through the other side glass fiber layer 230a. The glass fiber layer 230c on the other side is laminated on the semi-rigid urethane foam layer 230b so as to face the one side glass fiber layer 230a through the semi-rigid urethane foam layer 230b.

In the hard layer 230, the lamination of the semi-rigid urethane foam layer 230b with the one side glass fiber layer 230a and the lamination of the semi-rigid urethane foam layer 230b with the other side glass fiber layer 230c is achieved, for example, by impregnation of liquid isocyanate and subsequent curing thereof. Note that the impregnation of isocyanate is made over the one side glass fiber layers 230a, the other side glass fiber layer 230c, and the semi-rigid urethane layer 230b.

In the second embodiment, the volume density of semi-rigid urethane foam which is the forming material of the semi-rigid urethane foam layer 230b is set to a value (e.g., 0.03 g/cm³) within a predetermined volume density range. Herein, the predetermined volume density range is a range required for the semi-rigid urethane foam layer 230b to exhibit appropriate rigidity and good sound-insulating performance, and is set to be, for example, 0.015 g/cm³ to 0.1 g/cm³,

The reason why the lower limit of the predetermined volume density range is set at 0.015 g/cm³ is because the semi-rigid urethane foam layer 230b lacks the necessary rigidity and sound-insulating performance below this lower limit. The reason why the upper limit of the predetermined volume density range is set at 0.1 g/cm³ is because the semi-rigid urethane foam layer 230b becomes too heavy if the value is larger than the upper limit.

The one side and other side glass fiber layers 230a and 230c are formed of a plurality of glass fibers. The one side and other side glass fiber layers 230a and 230c serve to further improve the rigidity and sound-insulating performance of the semi-rigid urethane foam layer 230b under the above-described impregnation of isocyanate and curing thereof.

The hard layer 230 exhibits good sound-insulating performance, thereby to be capable of playing a role in maintaining even better sound-insulating performance as the service hole cover member 200, in combination with the sound-insulating performance of the film layer 220. As a result, the hard layer 230 exerts good sound-insulating performance.

On the other hand, assembling of the service hole cover member 200 to the inner panel 30 is performed by pressing the outer peripheral portion of the service hole cover member 200 onto the inner panel 30 with the plurality of pressing tools 50. Here, assuming that the service hole cover member 200 is formed only of the cushion layer 210, the cushion layer 210 may not be uniformly abutted on the inner panel 30 by pressing with the plurality of pressing tools 50 described above. This results in occurring a gap between the cushion layer 210 and the inner panel 30. As a result, entry of sounds or noises and/or moisture into the inner side of the inner panel 30 from the side of the outer panel 20 cannot be prevented.

Assuming that the hard layer 230 has the same flexibility as that of the cushion layer 210, even if the hard layer 230 is laminated on the cushion layer 210, the hard layer 230 cannot play a role in making the cushion layer 210 abut uniformly on the inner panel 30 by the pressing described above. As a result, a gap still occurs between the cushion layer 210 and the inner panel 30.

In contrast, if the hard layer 230 has appropriate rigidity, the pressing described above can cause the cushion layer 210 to abut on the inner panel 30 uniformly under the rigidity of the hard layer 230. Thus, the gap described above does not occur. Hence, it was decided to give the hard layer 230 appropriate rigidity.

The service hole cover member 200, that is, the three-layer laminated body 200, is formed of an outer peripheral laminated portion 200a, both upper and lower protruding laminated portions 200b and 200c, and an inter-laminate portion 200d corresponding to the outer peripheral laminated portion 100a, both the upper and lower protruding laminated portions 100b and 100c, and the inter-laminate portion 100d of the two-layer laminated body which is the service hole cover member 100 described in the first embodiment (see FIG. 10).

Here, the outer peripheral laminated portion 200a is formed as an outer peripheral portion of both the upper and lower protruding laminated portions 200b and 200c and the inter-laminate portion 200d in the three-layer laminated body 200.

Both the upper and lower protruding laminated portions 200b and 200c are formed to protrude toward the side of the inner panel 30 from the outer peripheral laminated portion 200a and the inter-laminate portion 200d of the three-layer laminate 200 in shapes that can be pressed into both upper and lower service holes 31 and 32 of the inner panel 30 so as to correspond to both the upper and lower service holes 31 and 32 of the inner panel 30 in place of both the upper and lower protruding laminated portions 100b and 100c described in the above first embodiment.

The inter-laminate portion 200d is interposed between both the upper and lower protruding laminated portions 200b and 200c in the three-layer laminate 200, thereby to serve to separate both the upper and lower protruding laminated portions 200b and 200c from each other.

In the three-layer laminated body 200, i.e., the service hole cover member 200 formed in this manner, both the upper and lower protruding laminated portions 200b and 200c are fitted by press-fitting into both the upper and lower service holes 31 and 32 of the inner panel 30 from the side of the door trim 40. Accordingly, the outer peripheral laminated portion 200a and the inter-laminate portion 200d abut on the assembly region (the region indicated by broken line R) of the inner panel 30.

In pressing the three-layer laminate 200 onto the inner panel 30 by the plurality of pressing tools 50 of the first embodiment, the plurality of pressing tools 50 are respectively fastened at a male screw portion 52 thereof onto a corresponding female threaded hole 34 of the inner panel 30 through a corresponding through hole 201 of a plurality of through holes 201 (only a single through hole 201 is shown in FIG. 10) of the outer peripheral laminated portion 200a, and presses with its flange portion 53 an outer peripheral portion of the through hole 201 of the outer peripheral laminated portion 200a onto the outer peripheral portion of the corresponding female threaded hole 34 of the inner panel 30. In addition, the plurality of through holes 201 are respectively formed in a through shape at a position corresponding to each of the plurality of through holes 101 of the two-layer laminated body 100 described in the first embodiment.

In the second embodiment configured in the above manner, assembling of the service hole cover member 200 to the inner panel 30 is performed as in the followings.

First, the service hole cover member 200 is placed at its cushion layer 210 so as to faces the inner panel 30 from the side of the door trim 40. At this time, the service hole cover member 200 is gripped at its upper protruding laminated portion 200b and lower protruding laminated portion 200c to face the upper service hole 31 and the lower service hole 32 of the inner panel 30. Accordingly, each through hole 201 of the service hole cover member 200 faces each female threaded hole 34 of the inner panel 30.

In such a state, the upper and lower protruding laminated portion 200b and 200c of the service hole cover member 200 are inserted into the upper and lower service hole 31 and 32 of the inner panel 30.

Here, the upper protruding laminated portion 200b is formed at an outer peripheral shape thereof so as to be capable of being press-fitted into the upper service hole 31, and the lower protruding laminated portion 200c is formed at an outer peripheral shape thereof so as to be capable of being press-fitted into the lower service hole 32. Hence, the upper protruding laminated portion 200b is inserted firmly in an airtight and liquid-tight manner into the upper service hole 31, and the lower protruding laminated portion 200c is inserted firmly in an airtight and liquid-tight manner into the lower service hole 32.

Therefore, sounds or noses, gases (e.g., air), and liquids (e.g., water) do not pass between the outer peripheral portion of the upper protruding laminated portion 200b and the inner peripheral portion of the upper service hole 31, and between the outer peripheral portion of the lower protruding laminated portion 200c and the inner peripheral portion of the lower service hole 32.

When both the upper and lower protruding laminated portions 200b and 200c are inserted into both the upper and lower service holes 31 and 32, as described above, each through hole 201 of the service hole cover member 200 is coaxially abutted on each corresponding female threaded hole 34 of the inner panel 30. In such a state, the plurality of pressing tools 50 are sequentially fastened at the male screw portions 52 onto the corresponding female thread portions 34 of the inner panel 30 through the corresponding through holes 201 of the service hole cover member 200.

Here, the cushion layer 210 of the service hole cover member 200 is formed of a soft urethane layer, as described above. The soft urethane forming the soft urethane layer is flexible and elastic.

The hard layer 230 of the service hole cover member 200 is formed by a three-layer laminated structure formed of the one side glass fiber layer 230a, the semi-rigid urethane layer 230b, and the other side glass fiber layer 230c, as described above. In the three-layer laminate structure, semi-rigid urethane forming the semi-rigid urethane layer 230b has rigidity. Both the glass fiber layers 230a and 230c are formed by combining a plurality of glass fibers, and the plurality of glass fibers have rigidity. Moreover, both the glass fiber layers 230a and 230c are further reinforced respectively at rigidity thereof by the impregnation of the isocyanate and curing described above.

Accordingly, in the hard layer 230, the semi-rigid urethane layer 230b can exert good rigidity together with both the glass fiber layers 230a and 230c. This means that the hard layer 230 is hard to deform, differed from the cushion layer 210. In other words, the corresponding hard layer portion of the hard layer 230 to the outer peripheral laminated portion 200a of the service hole cover member 200 (the three-layer laminated body 200) is hard to deform, differed from the corresponding cushion layer portion of the cushion layer 210 to the outer peripheral laminated portion 200a of the three-layer laminated body 200.

Accordingly, when the fastening is performed, as described above, the above-described corresponding hard layer portion of the hard layer 230 is pressed to compress the above-described corresponding cushion layer portion of the cushion layer 210 by each flange portion 53 of the plurality of pressing tools 50 through the corresponding film layer portion of the film layer 220 to the outer peripheral laminate portion 200a of the service hole cover member 200.

This means that the service hole cover member 200 adheres airtightly and liquid-tightly to the outer peripheral portion of each female threaded hole 34 of the inner panel 30 at a corresponding laminated portion (outer peripheral portion of each through hole 201) of the outer peripheral laminate portion 200a corresponding to the flange portion 53 of each pressing tool 50. Therefore, noises or sounds, gases, and liquids do not pass through any of the female threaded holes 34 of the inner panel 30 and the corresponding through holes 201 of the outer peripheral laminated portion 200a of the service hole cover member 200.

In addition, the larger an outer diameter of the flange portion 53 of each pressing tool 50 is, the wider the range of adhesion of the above-described corresponding laminated portion (the outer peripheral portion of each through hole 201) of the outer peripheral laminated portion 200a to the outer peripheral portion of each female threaded hole 34 is. Moreover, the above-described corresponding hard layer portion of the hard layer 230 is hard to deform, as described above.

As a result of the fastening or tightening described above, each laminated portion of the outer peripheral laminated portion 200a, which is located correspondingly between the flange portions 53 of each of both the adjacent pressing tools 50 of the plurality of pressing tools 50, can be well adhered to each corresponding portion of the inner panel 30 to each laminated portion of the outer peripheral laminated portion 200a.

According to the above description, the three-layer laminated body 200 can be adhered favorably to the assembly region of the inner panel 30 under compression of the cushion layer 210. This means that sounds or noises, gases, and liquids cannot enter the vehicle compartment 10 through a gap between the outer panel 20 and inner panel 30 by way of the inner panel 30 and the service hole cover member 200.

In the state in which the service hole cover member 200 is assembled to the inner panel 30 of the door body Da of the door D, the motor vehicle is assumed to put into a running condition. In such a condition, liquid (e.g., water droplets) may enter the gap between the outer panel 20 and the inner panel 30 through the hinge hole 21 of the outer panel 20 of the door body Da and/or the gap between the upper ends of the outer panel 20 and the inner panel 30, as in the first embodiment.

In addition, road noises and/or wind noises may be incident toward the inner panel 30 through the outer panel 20, as in the first embodiment. Furthermore, road noises and (or) wind noises may be incident between the outer panel 20 and the inner panel 30 from the hinge hole of the outer panel 20.

In view of the above, in the second embodiment, the cushion layer 210 can exert both of good sound-absorbing performance and good waterproof performance as in the case of the cushion layer 110 described in the first embodiment.

In addition to the above, as described above, the upper protruding laminated portion 210b of the service hole cover member 200 is inserted firmly in an airtight and liquid-tight manner into the upper service hole 31 of the inner panel 30, and the lower protruding laminated portion 200c of the service hole cover member 200 is inserted firmly in an airtight and liquid-tight manner into the lower service hole 32 of the inner panel 30.

Also, as described above, the three-layer laminated body 200 (the service hole cover member 200) is airtightly and liquid-tightly adhered to the outer peripheral portion of each female threaded hole 34 of the inner panel 30 at the corresponding laminated portion to each flange portion 53 of the outer peripheral laminated portion 200a, under the flexibility of the cushion layer 210 and the rigidity of the hard layer 230. Furthermore, as described above, each laminated portion of the outer peripheral laminated portion 200a of the three-layer laminate 200, which is located correspondingly between both the pressing tools 50, is also adhered well to portions of the inner panel 30 corresponding to each laminated portion of the outer peripheral laminate portion 200a, under the flexibility of the cushion layer 210 and the rigidity of the hard layer 230.

Therefore, even if water droplets enter between the outer panel 20 and inner panel 30, as described above, the water droplets can be well prevented from entering the region between the inner panel 30 and the door trim 40 by the cushion layer 210 with the waterproof performance of the cushion layer 210. As a result, the interior of the vehicle compartment 20 can be well waterproofed.

Even if road noises and/or wind noises are also incident between the outer panel 20 and the inner panel 30, as described above, the road noises and/or wind noises can be well absorbed by the soft layer 210 with the sound-absorbing performance of the soft layer 210.

Also, even if the road noises and/or wind noises that have been absorbed and attenuated in this manner are incident on the film layer 220 from the soft layer 210, the road noises and/or wind noises can be well insulated by the film layer 220 with the sound-insulating performance of the film layer 220. Furthermore, even if road noises and/or wind noises insulated and attenuated in this way are incident on the hard layer 230 from the film layer 220, such road noises and/or wind noises can be even better insulated by the above-described three-layer laminated structure of the hard layer 230 with the sound-insulating performance of the above-described three-layer laminated structure.

This allows the interior of the vehicle compartment 20 to be well soundproofed by the service hole cover member 200 with the sound-absorbing performance of the cushion layer 210 and the sound-insulating performance of the film layer 220 and the hard layer 230.

According to the above description, the service hole cover member 200 can be provided as a service hole cover member of a single component for a door of a motor vehicle which is capable of exhibiting also good waterproof performance, in addition to good sound-absorbing performance and good sound-insulating performance.

### Third Embodiment

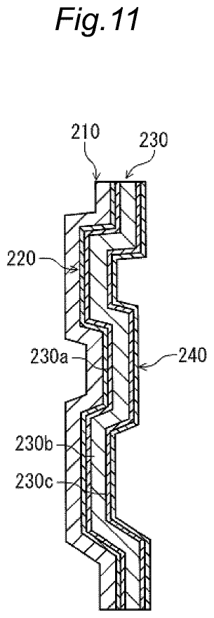

FIG. 11 shows a third embodiment of a service hole cover member for a door of a motor vehicle according to the present invention. The door service hole cover member of the third embodiment includes a configuration in which a skin layer 240 is added to the service hole cover member 200 described in the second embodiment.

The skin layer 240 is formed of a non-woven fabric layer made of a non-woven fabric. The skin layer 240 is laminated on the hard layer 230 described in the second embodiment so as to face the film layer 220 through the hard layer 230.

The reason for adopting the skin layer 240 in the third embodiment is as follows.

In the hard layer 230, the other side glass fiber layer 230c is adhered to the semi-rigid urethane layer 230b under the impregnation of the liquid isocyanate to the semi-rigid urethane layer 230b and the curing of the liquid isocyanate, as described in the second embodiment.

However, during the process of the adhesion described above, if the liquid isocyanate impregnated between the semi-rigid urethane layer 230b and the other side glass fiber layer 230c oozes or seeps out from the other side glass fiber layer 230c toward the opposite side (the surface side of the other side glass fiber layer 230c) to the semi-rigid urethane layer 230b, the appearance of the other side glass fiber layer 230c of the service hole cover member 100 from the surface side will be spoiled or degraded.

Therefore, it is decided to laminate the skin layer 240 onto the other side glass fiber layer 230c from its surface side. According to this configuration, the skin layer 240 absorbs with its non-woven fabric the above-described seepage of the liquid isocyanate from the surface side of the other side glass fiber layer 230c, thereby to be capable of serving to maintain the good appearance of the service hole cover member 200. This is the reason for adopting the skin layer 240.

In the third embodiment, the skin layer 240 is set to have a thickness (e.g., 50 μm) within a predetermined thickness range and a volume density (e.g., 100 g/cm³) within a predetermined volume density range. In addition, the non-woven fabric is made of synthetic resin fiber such as polyethylene terephthalate (PET), nylon or the like.

Herein, the predetermined thickness range of the non-woven layer which is the forming material of the skin layer 240 is set to, for example, 0.1 mm to 1 mm. The reason why the lower limit of the predetermined thickness range is set at 0.1 mm is because it is difficult to manufacture the non-woven layer below the lower limit. The reason why the upper limit of the predetermined thickness range is set at 1 mm is because if the non-woven layer is thicker than the upper limit, it will hinder the light weight of the service hole cover member 200.

In addition, the predetermined volume density range of the non-woven layer is set to, for example, 10 g/cm³ to 300 g/cm³. The reason why the lower limit of the predetermined volume density range is set at 10 g/cm³ is because it is difficult to manufacture the non-woven layer below this lower limit. The reason why the upper limit of the predetermined volume density range is set to 300 g/cm³ is because if the non-woven layer has a volume density greater than the upper limit, it will hinder the light weight as the service hole cover member 200. Other configurations of the third embodiment are the same as those of the second embodiment.

In the third embodiment configured in this way, the skin layer 240 made of a non-woven layer is laminated to the other side glass fiber layer 230c from its surface side. Accordingly, for adhering the other side glass fiber layer 230c and the semi-rigid urethane layer 230b by impregnating and curing of the liquid isocyanate as described above, even if the liquid isocyanate seeps out to the surface side of the other side glass fiber layer 230c during the process of the impregnating, the seeping isocyanate can be well absorbed by the skin layer 240 with its non-woven fabric.

This allows the skin layer 240 to maintain the good appearance of the service hole cover member 200 when viewed from the side of the other side glass fiber layer 230c. Other operation/working-effects of the third embodiment are the same as those of the second embodiment.

Note that in carrying out of the present invention, the following various modifications can be made, not limited to the above embodiments.
(1) In carrying out of the present invention, the forming material of the cushion layer 110 or 210 may be, for example, rubber foam or elastomer foam that can exhibit waterproof performance in addition to sound-absorbing performance as in the soft urethane foam, without limitation to the soft urethane foam described in the first or second embodiment. And, in general, the forming material of the cushion layer 110 or 210 may be any flexible elastic material with waterproof performance and sound-absorbing performance.
(2) In carrying out of the present invention, the forming material of the film layer 220 may be, for example, a polymeric material having sound-insulating performance, such as polypropylene (PP), polyethylene (PE), polyethylene terephthalate (PET) or the like, without limitation to nylon as described in the second embodiment.
(3) In carrying out of the present invention, the film layer 220 described in the second embodiment may be a sheet made of a sound insulation material. In addition, since the film layer 220 has non-air permeable performance, it may be a non-air permeable layer made of non-air permeable material instead of the film layer 220.
(4) In carrying out of the present invention, the number of service holes of the inner panel 30 into which the service hole cover member 100 or 200 is assembled may be, for example, one, three, or generally at least one or more, differing from the above embodiments.
(5) In carrying out of the present invention, the forming position and number of the through holes in the service hole cover member described in the first or second embodiment may be changed as necessary. In this case, the forming position of each through hole in the service hole cover member may be as long as it is as close as possible to the service hole in the inner panel.

For example, if it has both the upper and lower service holes 31 and 32, as in the inner panel 30 of the first embodiment, the through holes 101 may be formed at predetermined intervals (e.g., equal intervals) in positions which correspond to the outer peripheral portions (outer peripheral portions as close as possible to inner peripheral portions of both of the upper and lower service holes 31 and 32) except for the common outer periphery portion 33 among outer peripheral portions of both of the upper and lower service holes 31 and 32. Alternatively, the through holes 101 may be formed at predetermined intervals (e.g., equal intervals) in portions which correspond to the outer peripheral portions including the common outer periphery portion 33 among outer peripheral portions of both of the upper and lower service holes 31 and 32.

The number of through holes in the service hole cover member may be a number such that the service hole cover member can be uniformly adhered to the outer peripheral portion of the service hole at the corresponding location to the outer peripheral portion of the service hole, in connection with the forming position of the through holes in the service hole cover member.

Note that the forming position and number of the female threaded hole 34 in the inner panel 30 may correspond to the forming position and number of the through holes 101 in the service hole cover member 100. The above is also true for the service hole cover member 200.
(6) In carrying out of the present invention, the board member 120 referred to in the first embodiment may also be a board layer made of various synthetic resin materials and other non-metallic materials that have sound-insulating performance and rigidity, without limitation to a board layer made of foamed polypropylene.
(7) In carrying out of the present invention, the service hole cover member 100 of the first embodiment may be formed in a flat plate shape without forming both the upper and lower protruding laminated portions 100b and 100c.

In this case, if the adhesion state between the outer peripheral portions of both the upper and lower service holes 31 and 32 and the corresponding portions of the cushion layer 110 to the outer peripheral portions of both the upper and lower service holes 31 and 32 is secured by a plurality of pressing tools 50 with pressure thereof, entry of liquid and/or sounds or noises toward the side of the door trim member 40 from between each outer peripheral portion of both the upper and lower service holes 31 and 32 and each corresponding portion of the cushion layer 110 to each outer peripheral portion of both the upper and lower service holes 31 and 32 can be well prevented.
(8) In carrying out of the present invention, the service hole cover member 200 referred to in the second embodiment may be formed in a flat plate shape without forming both the upper and lower protruding laminate portions 200b and 200c.

In this case, if the adhesion state between the outer peripheral portions of both the upper and lower service holes 31 and 32 and the corresponding portions of the cushion layer 110 to the outer peripheral portions of both the upper and lower service holes 31 and 32 is secured by a plurality of pressing tools 50 with pressure thereof, entry of liquid and/or sounds or noises toward the side of the door trim member 40 from between each outer peripheral portion of both the upper and lower service holes 31 and 32 and each corresponding portion of the cushion layer 210 to each outer peripheral portion of both the upper and lower service holes 31 and 32 can be well prevented.
(9) In carrying out of the present invention, the service hole cover member 100 or 200 may be assembled to an inner panel of the front right door, rear left door, or rear right door from the opposite side of an outer panel so as to cover service holes of the inner panel, without limitation to the front left door D described in the above embodiment.
(10) In carrying out of the present invention, each female threaded hole 34 of the inner panel 30 may be formed as a through hole, unlike the above embodiment, and the male screw portion 52 of the pressing tool 50 may be formed as a press-fit portion that can be press-fitted into each through hole instead of each female threaded hole 34, unlike the above embodiment. According to this configuration, the same work/effects as those of the pressing tool 50 of the above embodiment can be obtained.
(11) In carrying out of the present invention, the assembly of the service hole cover member to the inner panel 30 is not limited to assembly using the pressing tool 50 described in the above embodiment, but any assembly configuration is acceptable, as long as the service hole cover member can be assembled to the inner panel 30 in a liquid-tight and airtight manner.
(12) In carrying out of the present invention, the number of protruding laminated portion of the service hole cover member may be one, and generally at least one or more, differed from the above embodiments.

What is claimed is:

1. A service hole cover member applied to a door of a motor vehicle, comprising:
a cushion layer abutted along an inner panel, which is located facing an outer panel, from the side of said inner panel opposite to said outer panel so as to cover at least one service hole formed in said inner panel, said outer panel and said inner panel being included in a door body provided in said door, and
a board member laminated on said cushion layer so as to face said inner panel through the cushion layer,
wherein said cushion layer is formed of a flexible elastic material having waterproof performance in addition to sound-absorbing performance, and
wherein said board member is formed so as to have a board shape with a non-metallic material having sound-insulating performance and rigidity.

2. The service hole cover member for a door of a motor vehicle according to claim 1,
wherein said flexible elastic material that is a forming material of said cushion layer is soft urethane foam, rubber foam, or elastomer foam having a volume density within a predetermined volume density range, and
wherein said predetermined volume density range is set so that said soft urethane foam, said rubber foam, or said elastomer foam exerts waterproof performance.

3. The service hole cover member for a door of a motor vehicle according to claim 2, wherein said predetermined volume density range is set to 0.005 g/cm³ to 0.1 g/cm³.

4. The service hole cover member for a door of a motor vehicle according to claim 1, wherein said non metallic material that is a forming material of said board member is a synthetic resin material having sound-insulating performance and rigidity.

5. The service hole cover member for a door of a motor vehicle according to claim 1,
wherein said board member is formed so as to have a board shape with a two-layer laminated body including both of a non-air permeable layer laminated on said cushion layer so as to face said inner panel through said cushion layer, and a hard layer laminated on said non-air permeable layer so as to face said cushion layer through the non-air permeable layer,
wherein said non-air permeable layer is formed of a polymeric material having sound-insulating performance,
wherein said hard layer includes a semi-rigid urethane foam layer and both glass fiber layers,
said semi-rigid urethane foam layer is formed of semi-rigid urethane foam having sound-insulating performance and rigidity, and
said both glass fiber layers are respectively formed of a plurality of glass fibers, and
wherein one glass fiber layer of both the glass fiber layers is laminated on said non-air permeable layer as one side glass fiber layer so as to face said cushion layer through said non-air permeable layer,
said semi-rigid urethane foam layer is laminated on said one side glass fiber layer so as to face said non-air permeable layer through said one side glass fiber layer, and
the other glass fiber layer of said both glass fiber layers is laminated on said semi-rigid urethane form layer as the other side glass fiber layer so as to face said one side glass fiber layer through said semi-rigid urethane form layer.

6. The service hole cover member for a door of a motor vehicle according to claim 1, comprising:
an outer peripheral laminated portion and at least one protruding laminated portion formed so as to correspond to said at least one service hole of said inner panel at an inner peripheral side of the outer peripheral laminate portion,
wherein said at least one protruding laminated portion is formed to protrude from said outer peripheral laminated portion so as to be press-fitted into said at least one service hole from the opposite side of said inner panel to said outer panel.

7. The service hole cover member for a door of a motor vehicle according to claim 5, further comprising:
an outer peripheral laminated portion, and at least one protruding laminated portion formed so as to correspond to said at least one service hole of said inner panel at an inner peripheral side of the outer peripheral laminated portion,
wherein said at least one protruding laminated portion is formed to protrude from said outer peripheral laminated portion so as to be press-fitted into said at least one service hole from the opposite side of said inner panel to said outer panel.

8. The service hole cover member for a door of a motor vehicle according to claim 5, comprising:
a skin layer of non-woven fabric laminated on said other side glass fiber layer so as to face said semi-rigid urethane foam layer through said other side glass fiber layer,
wherein lamination of said other side glass fiber layer to said semi-rigid urethane foam layer is performed by impregnation of liquid isocyanate and its curing to said other side glass fiber layer.
